(19) United States
(12) Patent Application Publication
(10) Pub. No.: US 2021/0264639 A1
(43) Pub. Date: Aug. 26, 2021

(54) DETERMINATION OF DEFECTS IN LIGHT SOURCES INTEGRATED WITH CAMERAS

(71) Applicant: Hewlett-Packard Development Company, L.P., Spring, TX (US)

(72) Inventors: Emily Ann Miginnis, San Diego, CA (US); Yow Wei Cheng, Taipei City (TW)

(73) Assignee: Hewlett-Packard Development Company, L.P., Spring, TX (US)

(21) Appl. No.: 17/265,901

(22) PCT Filed: Nov. 14, 2018
(86) PCT No.: PCT/US2018/060934

§ 371 Date: Feb. 4, 2021

(51) Int. Cl. G06T 7/90; G01N 21/25

(52) U.S. Cl. CPC G06T 7/90; G06T 2207/10024; G01N 21/255; G01N 21/251

(57) ABSTRACT

An example non-transitory machine-readable storage medium includes instructions to determine whether a light source associated with a camera has a defect. When executed, the instructions cause a processor of a computing device to cause the light source associated with the camera to emit light toward a reflective test surface to illuminate the reflective test surface, the light source integrated with the camera to emit light during normal operation of the camera. The instructions further cause the processor to cause the camera to capture an image of the reflective test surface illuminated by the light source. The instructions further cause the processor to analyze the captured image to determine whether the light source has a defect. The instructions further cause the processor to output an indication of the defect when determined.

### BACKGROUND

A camera may be associated with a light source which emits light during normal operation of the camera. For example, a camera of a notebook computer may be coupled with a privacy indicator, such as a light-emitting diode (LED), to indicate whether the camera is in operation. As another example, a camera of a smartphone may be coupled with a flash LED which is timed to flash when the camera captures an image. These light sources may be inspected or tested for defects by human operators or by automated testing electronics.

### BRIEF DESCRIPTION OF THE DRAWINGS

FIG. 1 is a schematic diagram of an example non-transitory machine-readable storage medium. The storage medium stores instructions to cause a processor of a computing device to determine whether a light source associated with a camera has a defect.

FIG. 2 is a schematic diagram of an example computing device, the computing device including a camera, a light source associated with the camera, and a processor to determine whether the light source has a defect.

FIG. 3 is a schematic diagram of an example testing apparatus for testing a light source of an imaging device for a defect.

FIG. 4A is a schematic diagram of an example reflective surface illuminated by light sources associated with a camera, wherein the light sources are functioning properly.

FIG. 4B is a schematic diagram of another example reflective test surface illuminated by light sources associated with a camera, where some of the light sources have defects.

FIG. 5 is a schematic diagram of an example positioning apparatus and reflective test surface of a testing apparatus.

FIG. 6 is a flowchart of an example method for determining whether a light source associated with a camera has a defect.

FIG. 7 is a flowchart of an example method for analyzing an image to determine whether a light source associated with a camera has a defect.

FIG. 8 is a flowchart of an example method for analyzing an image using an image mask to determine whether a light source associated with a camera has a color defect.

FIG. 9 is a schematic diagram showing an example reflective test surface, corresponding image mask, and corresponding masked image.

### DETAILED DESCRIPTION

A light source associated with a camera may be tested for a defect by a human operator or by automated testing electronics. A human operator may visually inspect a light source to verify that the light source is operational. However, manual visual inspection may cause fatigue or injury to the operator. Automated testing electronics may include sensors such as photosensors to test for brightness or colorimeters to test for color. However, it is an added expense to store and maintain such automated testing electronics.

A light source associated with a camera may be tested for a defect, without manual inspection or automated testing electronics, by causing the light source to illuminate a reflective surface, causing the camera to capture an image of the illuminated reflective surface, and analyzing the captured image for a defect in the light source.

Such a process may be executable according to machine-readable instructions. Thus, a non-transitory machine-readable storage medium may include instructions that, when executed, cause a processor of a computing device to determine whether a light source associated with a camera has a defect. When executed, the instructions may cause the light source associated with the camera to emit light toward a reflective test surface to illuminate the reflective test surface. The instructions may further cause the processor to cause the camera to capture an image of the reflective test surface illuminated by the light source. The instructions may further cause the processor to analyze the captured image to determine whether the light source has a defect. The instructions may further cause the processor to output an indication of the defect when determined.

The light source may be integrated with the camera to emit light during normal operation of the camera. Further, the light source and the camera may be included together in a computing device. For example, the light source may be a privacy LED of a notebook computer camera, or a flash LED of a smartphone camera. Further, the instructions to determine whether the light source has a defect may be executed by the computing device which includes the light source and the camera. Thus, it may be determined whether the light source has a defect using the computing device itself without additional testing electronics. The instructions may be executed by a different computing device or combination of computing devices, such as, for example, a quality assurance computer on an assembly line.

After an image of the reflective surface illuminated by the light source is captured, the captured image may be analyzed for an indication of a defect. The analysis of the captured image may involve identifying and analyzing light blobs in the captured image to determine whether there is a defect. A light blob is a region of an image having the same or similar visual properties caused by illumination from a light source. A light blob may appear as a circular spot, an oval, or another shape, and may vary in brightness, color, or other properties, depending on the properties of the light source, the camera, and the arrangement of the light source and camera with respect to the reflective testing surface. In determining whether there is a defect, for example, a plurality of light blobs may be counted to determine whether the expected number of light sources have successfully illuminated. As another example, a light blob may be analyzed for size to determine whether the light source which produced the light blob is of the expected brightness. As yet another example, a light blob may be analyzed for color temperature to verify that the light source which produced the light blob is emitting the expected wavelengths of light. A light source may thereby be tested for compliance with specifications.

The analysis may also involve image processing techniques, such as converting the captured image to monochrome, cropping a region of interest, applying Gaussian blurring, converting the image to a binary image, applying an erosion operation, generating an image mask, or other techniques to prepare the image for analysis. The analysis of light blobs may involve connected component labelling, contour scanning, or feature recognition techniques. Thus, the instructions may thereby cause a processor of a computing device to determine whether a light source associated with a camera has a defect.

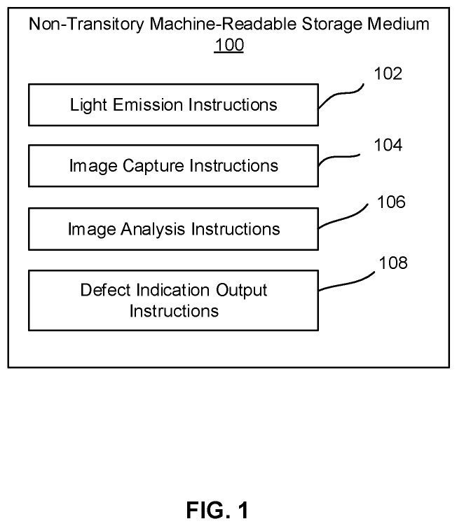

FIG. 1 is a schematic diagram of an example non-transitory machine-readable storage medium 100 which stores such instructions. The instructions cause a processor of a computing device to execute tasks to determine whether a light source associated with a camera has a defect. The computing device may include a notebook computer, desktop computer, smartphone, server, or any computing device or combination of computing devices having a non-transitory machine-readable storage medium. In some examples, the light source and the camera may be part of the computing device. For example, the light source may be a privacy LED of a notebook computer camera or a flash LED of a smartphone camera. The light source may also be a backlit display or lighting for a projection system.

The storage medium 100 includes light emission instructions 102 to cause a light source associated with a camera to emit light toward a reflective test surface to illuminate the reflective test surface. The light source is integrated with the camera to emit light during normal operation of the camera.

The light emitted to the reflective test surface may produce a light blob on the reflective test surface. In some examples, the light emission instructions 102 may include instructions to cause a plurality of light sources associated with a camera to emit light toward the reflective test surface to illuminate the reflective test surface. Thus, the light emitted to the reflective test surface may produce a plurality of light blobs on the reflective test surface.

The storage medium 100 further includes image capture instructions 104 to cause the camera to capture an image of the reflective test surface illuminated by the light source or sources.

The storage medium 100 further includes image analysis instructions 106 to analyze the captured image to determine whether the light source has a defect.

The image analysis instructions 106 may include instructions to identify a light blob in the captured image and to compare a characteristic of the light blob to a reference characteristic. For example, a size of a light blob may be compared to a reference size, or range of sizes, to determine whether the light source corresponding to the identified light blob is emitting light at the appropriate brightness. As another example, a color of the light blob may be compared to a reference color, or range of colors, to determine whether the light source corresponding to the identified light blob is emitting light at the appropriate wavelength.

The image analysis instructions 106 may include instructions to analyze the captured image for a plurality of light blobs. Thus, the image analysis instructions 106 may be used to determine whether a light source out of a plurality of light sources associated with a camera includes a defect. For example, a light blob out of a plurality of light bulbs may be identified, and a characteristic of the identified light blob may be compared to a reference characteristic, as discussed above. As another example, the captured image may be analyzed to count a quantity of light blobs in the captured image to determine whether any one of the plurality of light sources has a defect which prevents the light source from illuminating the reflective test surface. As yet another example, a position of a light blob with respect to another light blob may be analyzed to determine whether there is a defect in the positioning of a light source.

Light blobs may be identified using a connected component labeling algorithm or any contour finding/scanning algorithm. Further, a pattern of light blobs may be analyzed using a feature recognition algorithm to identify whether any of the light sources corresponding to the light blobs have a defect.

The storage medium 100 further includes defect indication output instructions 108 to output an indication of the defect when determined. The indication may include a record to be stored in memory, a message to be transmitted to a quality control system, an audio or visual alert, or any other indication. The indication of the defect may be incorporated into a log of indications of defects. Such a log may be used to diagnose failure points in a supply chain.

An indication that a light source has a defect may prompt maintenance of a light source, replacement of a light source, or replacement or maintenance of a device of which the light source and camera are a part. In some examples, an indication that a light source has a defect may prompt calibration of the camera. For example, when a light source is determined to have a defect, such as low brightness, off color, or unexpected light distribution, the camera may be calibrated to compensate for the different expected lighting conditions. In some examples, the storage medium 100 may include calibration instructions to automatically calibrate the camera to compensate for a defect identified in a light source.

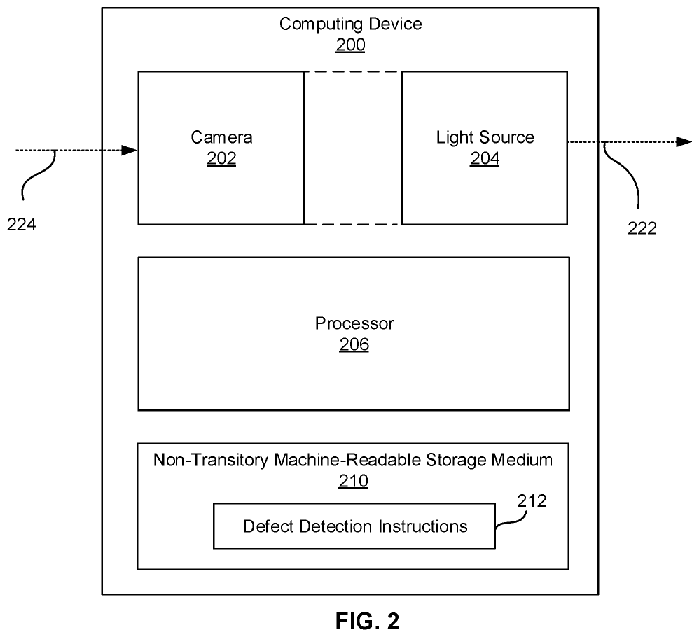

FIG. 2 is a schematic diagram of an example computing device 200. The computing device 200 includes a camera 202. The computing device 200 further includes a light source 204 integrated with the camera 202 to emit light 222 during normal operation of the camera 202. The light 222 is reflected off the reflective surface as reflected light 224 to be captured by the camera 202. The light source 204 may include an LED. In some examples, the light source may include a privacy light. In some examples, the light source 204 may include a camera flash. Although indicated as a single light source 204, it is to be understood that in other examples the light source 204 may include a plurality of light sources.

The computing device 200 further includes a processor 206 and a non-transitory machine-readable storage medium 210 storing defect detection instructions 212. The defect detection instructions 212 cause the processor 206 to cause the light source 204 to emit light 222 toward a reflective test surface to illuminate the reflective test surface. The instructions 212 further cause the processor 206 to cause the camera 202 to capture an image of the reflective test surface illuminated by the light source 204. The instructions 212 further cause the processor 206 to analyze the captured image to determine whether the light source 204 has a defect, and to output an indication of the defect when determined.

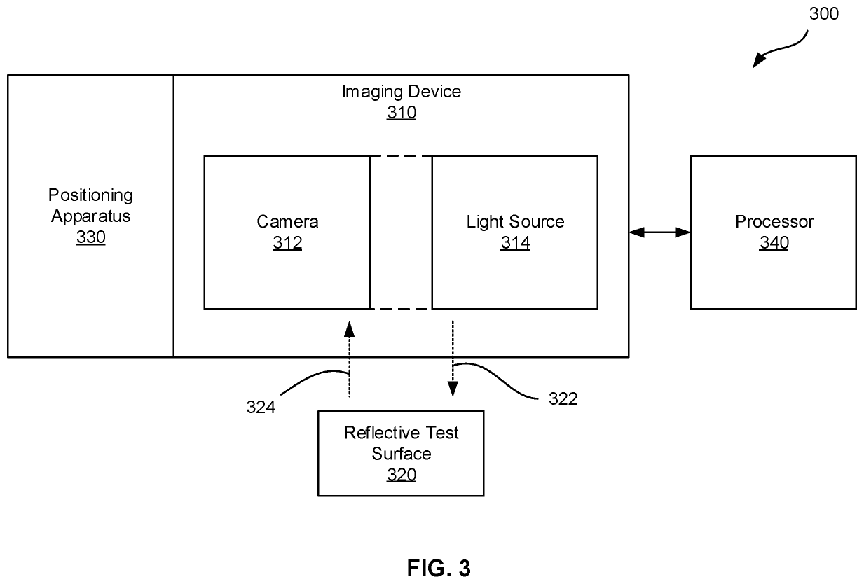

FIG. 3 is a schematic diagram of an example testing apparatus 300 for testing a light source of an imaging device for a defect. The testing apparatus 300 includes an imaging device 310 and a reflective test surface 320. The imaging device 310 includes a camera 312 and a light source 314. The light source 314 is integrated with the camera 312 to emit incident light 322 during normal operation of the camera 312. The reflective test surface 320 reflects the incident light 322 as reflected light 324. The camera 312 is to capture an image of reflected light 324 reflected from the reflective test surface 320.

The testing apparatus 300 further includes a positioning apparatus 330 to secure the imaging device 310 and to orient the camera 312 and the light source 314 toward the reflective test surface 320.

The testing apparatus 300 further includes a processor 340 to analyze the image of the reflected light 324 from the reflective test surface 320 to determine whether the light source 314 has a defect.

In some examples, the processor 340 and the imaging device 310 may be integrated into a computing device, such as a notebook computer or a smartphone. In such examples, the light source 314 may be a privacy LED associated with a notebook computer camera or a flash LED associated with a smartphone camera. In other examples, the processor 340 may be separate from the imaging device 310, such as a part of a quality assurance computer to monitor a plurality of testing apparatuses 300 along an assembly line.

The testing apparatus 300 may be used to test the camera 312 and 314 over trials. Variables which may affect the image captured of the reflective test surface 320 may be varied over the trials. For example, camera exposure attributes, such as aperture size, exposure time, and native CMOS noise may be varied. As another example, the distance between the camera 312, the light source 314, and/or reflective test surface 320 may be varied.

The quantum efficiency curve of the camera 312 may be selected to match with the wavelength spectra of the light source 314.

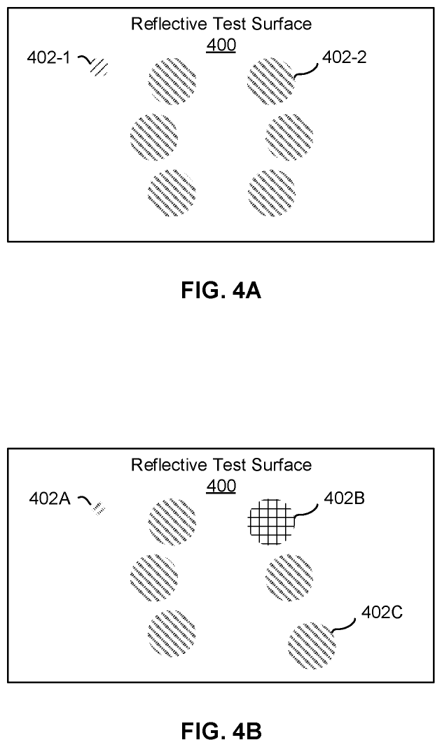

FIG. 4A is a schematic diagram of an example reflective test surface 400 illuminated by light sources associated with a camera. The reflective test surface 400 includes a plurality of light blobs 402 produced by light from light sources reflecting off the reflective test surface 400. The light blobs 402 may correspond to light sources of the same or different types. For example, the light blob 402-1 may correspond to a privacy LED, and the light blobs 402-2 may correspond to camera flash LEDs.

Although a plurality of light blobs is shown, it is to be understood that the reflective test surface 400 may include any number of light blobs 402, including a single light blob 402, or zero light blobs 402. The light blobs 402 are produced by light sources which are operating properly without defects.

FIG. 4B is a schematic diagram of another example reflective test surface 400 illuminated by light sources associated with a camera, where some of the light sources include defects. Thus, the reflective test surface 400 includes light blobs 402A, 402B, and 402C. The light blob 402A has a diameter smaller than an expected diameter of a reference light blob, indicating that the light source which produced the light blob 402A may be emitting light at a lower level of brightness than expected. The light blob 402B has a different color than an expected color of a reference light blob, indicating that the light source which produced the light blob 402B may be emitting light at a different wavelength than expected. The light blob 402C is located in a position with respect to the other light blobs 402 that is different from the expected position, indicating that the light source which produced the light blob 402C may be incorrectly positioned or oriented.

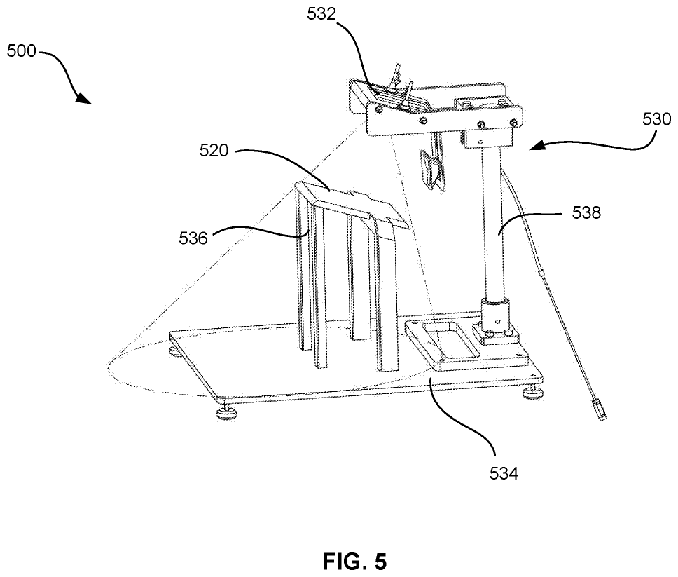

FIG. 5 is a schematic diagram of an example reflective surface 520 and positioning apparatus 530 for a testing apparatus for testing the light source of an imaging device for a defect. The reflective test surface 520 and positioning apparatus 530 may be similar to the reflective test surface 320 and positioning apparatus 330 of FIG. 3, and thus, for further description of the above elements, the description of the testing apparatus 500 of FIG. 5 may be referenced.

The positioning apparatus 530 may include retaining mechanism 532 to retain an imaging device in a position oriented toward the reflective test surface 520. The light source and camera of the imaging device may be oriented to be parallel to one another, and either directly facing the reflective test surface 520, or oriented at an angle with respect to the reflective test surface 520.

The positioning apparatus 530 may include a support base 534 to support a pedestal 536 and a support arm 538. The pedestal 536 may support the reflective test surface 520, and the support arm 538 may support the retaining mechanism 532. The support arm 538 may be articulable to orient the camera and the light source of the imaging device toward the reflective test surface 520.

The orientation and height of the reflective test surface 520 may be adjustable with respect to the pedestal 536 to suit the imaging device being tested. Further, the reflective test surface 520 may be replaceable to suit the imaging device being tested. For example, the reflective test surface 520 may include a replaceable mirror. Further, the positioning apparatus 530 may adjust the distance between the imaging device being tested and the reflective test surface 520 to accommodate the field of view of the camera and/or the lighting range of the light source.

In some examples, the reflective test surface 520 may include diffuser film. In such examples, the reflective test surface 520 may be used to measure the overall brightness of the light sources of the imaging device.

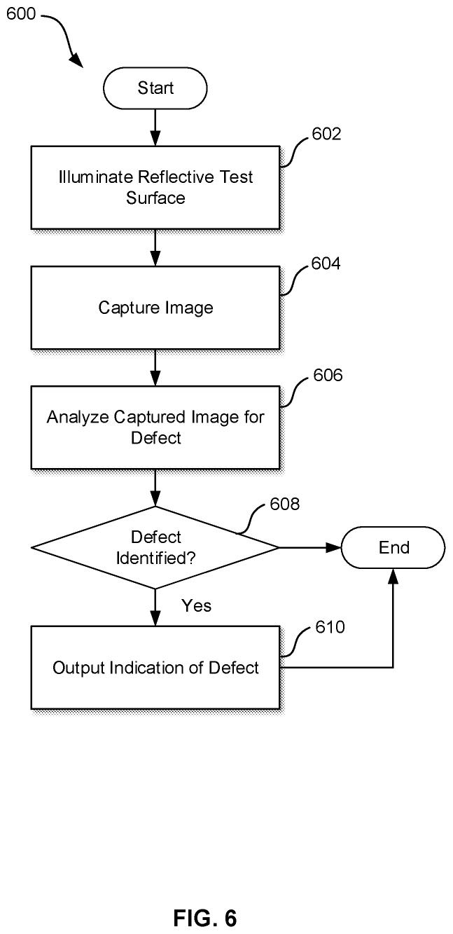

FIG. 6 is a flowchart of an example method 600 for determining whether a light source associated with a camera has a defect. The method 600 is one way in which to determine whether a light source associated with a camera has a defect. The method 600 may be performed using any instructions, computing device, or testing apparatus as described above, such as the instructions stored on storage medium 100, the computing device 200, or the testing apparatus 300. For clarity, the method 600 has been described with reference to the testing apparatus 300, but this is not limiting, and the method 600 may be performed by other systems, apparatuses, and/or devices.

At block 602, a light source 314 associated with a camera 312 emits light toward a reflective test surface 320 to illuminate a reflective test surface 320. The light source 314 is integrated with the camera 312 to emit light during normal operation of the camera 312. At block 604, the camera 312 captures an image of the reflective test surface 320 illuminated by the light source 314. At block 606, the processor 340 analyzes the captured image to determine whether the light source 314 has a defect. At block 608, it the processor 340 determines whether a defect has been identified. At block 610, the processor 340 outputs an indication of the defect when it is determined that there is a defect in the light source 314. In some examples, the light source 314 may include a plurality of light sources.

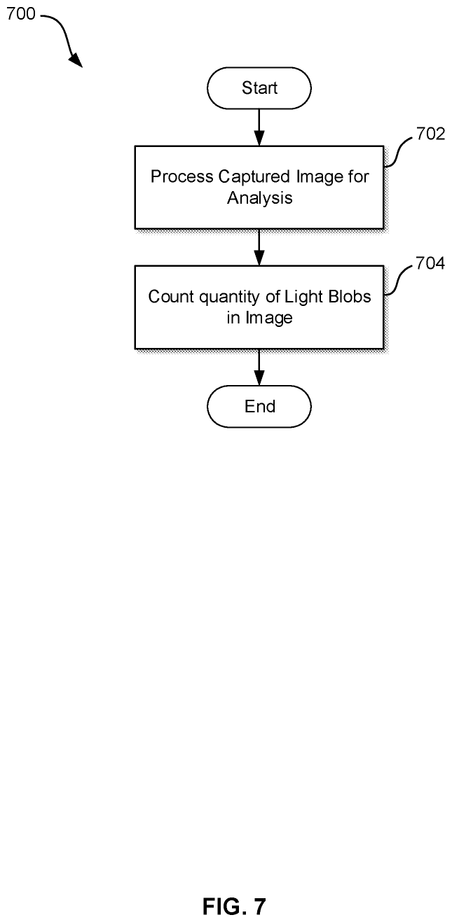

FIG. 7 is a flowchart of an example method 700 for analyzing an image to determine whether a light source associated with a camera has a defect. The method 700 is one way in which to analyze an image to determine whether a light source associated with a camera has a defect. The method 700 may be performed to implement block 606 of the method 600 of FIG. 6, and thus may be performed using any instructions, computing device, or testing apparatus as described above, such as the instructions stored on storage medium 100, the computing device 200, or the testing apparatus 300.

At block 702, the captured image is processed for analysis. Processing the captured image for analysis may include converting the image to a grayscale image. Converting the image to grayscale may be performed when examining light blobs for brightness or position.

Processing the captured image for analysis may include cropping the image to a region of interest. Cropping the image to a region of interest may be performed to eliminate peripheral image noise that may otherwise impact light blob detection.

Processing the captured image for analysis may include applying a smoothing algorithm such as Gaussian blur the image. Applying a smoothing algorithm to the image may eliminate small noise pixels that may erroneously impact light blob detection.

Processing the captured image for analysis may include converting the image to a binary image. Converting the image to a binary image may involve selecting a pre-defined threshold for converting pixels of a grayscale image to binary pixels. For example, an 8-bit grayscale image may be converted into a 2-bit binary image. Such thresholds may be selected to filter out small image noise such that only genuine light blobs which correspond to light sources are later identified as light blobs.

Processing the captured image for analysis may include applying an erosion operation to the image to produce an eroded image. In such examples, the erosion operation may be applied to a binary image. Applying an erosion operation to the binary image to erode edges of light blobs such that distinct light blobs may be distinctly identified.

In some examples, processing the captured image for analysis may include generating an image mask and applying the image mask to the image to eliminate pixels which do not correspond to identified light blobs. Generating the image mask may involve generating a binary image version of the image to be laid over the image to crop out pixels which do not correspond to identified light blobs. Thus, light blobs may be analyzed for defects, such as through counting light blobs, using an image mask.

At block 704, a quantity of light blobs in the image is counted. Counting a number of light blobs in the image may include applying a connected component labelling algorithm or an image contour scanning algorithm. In some examples, counting a quantity of light blobs in the image may include applying a feature matching algorithm to identify feature points of the image for comparison with a reference image to further eliminate image noise. Thus, it may be determined whether any light sources have a defect which prevented them from producing light blobs on the reflective test surface.

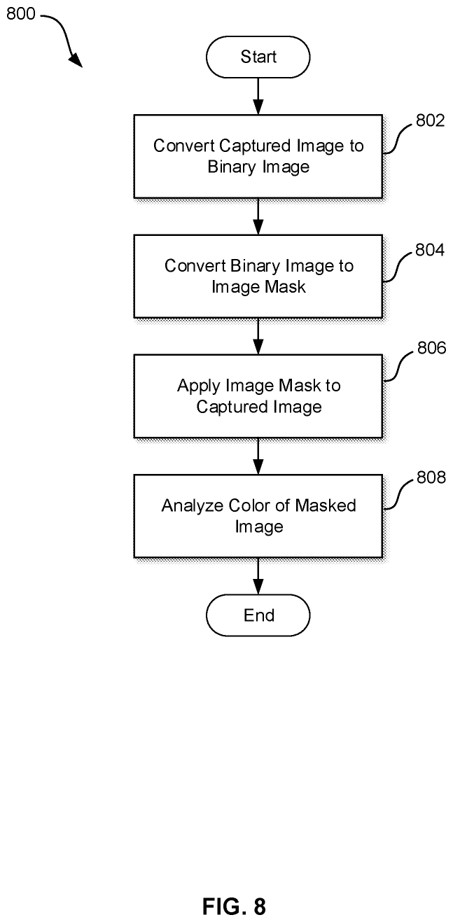

FIG. 8 is a flowchart of an example method 800 for analyzing an image using an image mask to determine whether a light source associated with a camera has a color defect. The method 800 is one way in which to analyze an image determine whether a light source associated with a camera has a defect. The method 800 may be performed to implement block 606 of the method 600 of FIG. 6, and thus may be performed using any instructions, computing device, or testing apparatus as described above, such as the instructions stored on storage medium 100, the computing device 200, or the testing apparatus 300.

At block 802, the captured image is converted into a binary image. At block 804, the binary image is converted into an image mask to crop out pixels which do not correspond to identified light blobs. At block 806, the image mask is applied to the captured image to produce a masked image in which only includes pixels which correspond to identified light blobs. At block 808, a color of the masked image is analyzed for color.

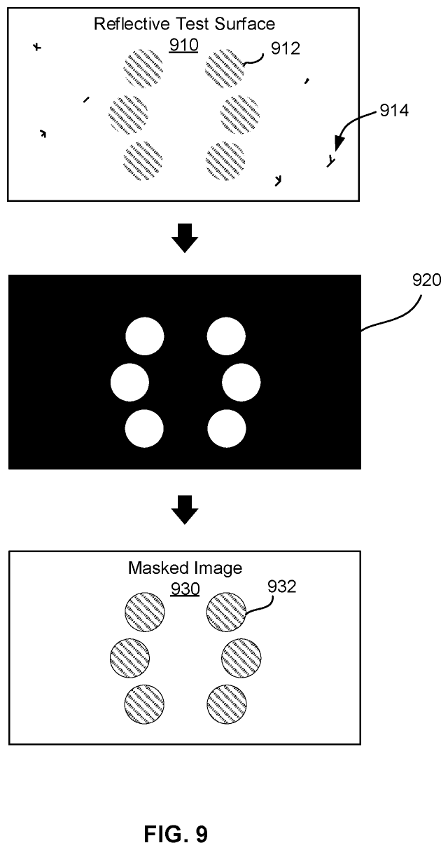

FIG. 9 is a schematic diagram showing an example reflective test surface 910, corresponding image mask 920, and corresponding masked image 930. The reflective test surface 910 includes light blobs 912 and image noise 914. The image mask 920 corresponding to the reflective test surface 910 may be generated as discussed above. The image mask 920 may be applied to the reflective test surface 910 to produce a masked image as discussed above including light blobs 932. Thus, an image of the light blobs 912 having reduced image noise may be analyzed for defects.

Thus, a light source, which may be of a plurality of light sources, may illuminate a reflective surface, and the camera may capture an image of the illuminated reflective surface. The captured image may be analyzed for defects in the light sources, and defects may be outputted when identified. Thus, light sources associated with cameras may be tested for defects without manual inspection or automated testing electronics. Less reliance on manual inspection may lead to reduced operator injury and instances of human error. A testing process which involves generating a log of light source defects may facilitate diagnosing liability for defects throughout a supply chain. Using the methods described herein, LED light sources may be inspected more reliably, enabling manufacturers to be more flexible in selecting LEDs (e.g. unbinned LEDs) to use in electronics. Further, in the case of light sources and cameras including in computing devices such as smart phones, ensuring that illumination power is consistent across the light sources may facilitate higher quality image capture, video capture, and scanned images.

The scope of the claims should not be limited by the above examples but should be given the broadest interpretation consistent with the description as a whole.

1. A non-transitory machine-readable storage medium comprising instructions that when executed cause a processor of a computing device to:
cause a light source associated with a camera to emit light toward a reflective test surface to illuminate the reflective test surface, the light source integrated with the camera to emit light during normal operation of the camera;
cause the camera to capture an image of the reflective test surface illuminated by the light source;
analyze the captured image to determine whether the light source has a defect; and
output an indication of the defect when determined.

2. The non-transitory machine-readable storage medium of claim 1, wherein the instructions cause the processor to identify a light blob in the captured image and compare a characteristic of the light blob to a reference characteristic in order to analyze the captured image.

3. The non-transitory machine-readable storage medium of claim 1, wherein the instructions cause the processor to count a quantity of light blobs in the captured image.

4. The non-transitory machine-readable storage medium of claim 1, wherein the instructions cause the processor to conduct feature recognition on a pattern of light blobs in the captured image.

5. The non-transitory machine-readable storage medium of claim 1, wherein the instructions cause the processor to convert the captured image to a binary image and count a quantity of light blobs in the binary image.

6. The non-transitory machine-readable storage medium of claim 1, wherein the instructions cause the processor to convert the captured image to a binary image, apply an erosion operation to the binary image to produce an eroded image, and count a quantity of light blobs in the eroded image.

7. The non-transitory machine-readable storage medium of claim 1, wherein the instructions cause the processor to convert the captured image to a binary image, convert the binary image to an image mask, apply the image mask to the captured image to produce a masked image, and analyze a color of the masked image.

8. The non-transitory machine-readable storage medium of claim 1, wherein the instructions cause the processor to generate and output a log of indications of defects.

9. The non-transitory machine-readable storage medium of claim 1, wherein the instructions cause the processor to calibrate the camera based on the defect.

10. A computing device comprising:
a camera;
a light source integrated with the camera to emit light during normal operation of the camera; and
a processor to cause the light source to emit light toward a reflective test surface to illuminate the reflective test surface, cause the camera to capture an image of the reflective test surface illuminated by the light source, analyze the captured image to determine whether the light source has a defect, and output an indication of the defect when determined.

11. The computing device of claim 10, wherein the light source comprises a privacy light.

12. The computing device of claim 10, wherein the light source comprises a camera flash.

13. A testing apparatus comprising:
a reflective test surface;
a positioning apparatus to secure an imaging device including a camera and a light source under test and to orient the camera and the light source toward the reflective test surface, the reflective test surface to reflect incident light from the light source as reflected light, the camera to capture an image of the reflected light, the light source integrated with the camera to emit the incident light during normal operation of the camera; and
a processor to analyze the image of the reflected light to determine whether the light source has a defect.

14. The testing apparatus of claim 13, wherein the reflective test surface comprises a replaceable mirror.

15. The testing apparatus of claim 13, wherein the reflective test surface comprises a diffuser film.
